(19) United States
(12) Patent Application Publication
(10) Pub. No.: US 2006/0209993 A1
(43) Pub. Date: Sep. 21, 2006

(54) Demodulator and receiver for pre-coded partial response signals

(76) Inventor: Wei Lu, Germantown, MD (US)

Correspondence Address: WELSH & KATZ, LTD, 120 S RIVERSIDE PLAZA, 22ND FLOOR, CHICAGO, IL, 60606, US

(21) Appl. No.: 11/061,807

(22) Filed: Feb. 18, 2005

(51) Int. Cl. H04L 27/14

(52) U.S. Cl. 375/336

(57) ABSTRACT

An improved demodulation mechanism (and corresponding methods of operation) that demodulates a differentially-encoded GMSK signal in a manner that is accurate and efficient and with reduced complexity. The demodulation mechanism includes at least one buffer for storing sequences of in-phase and quadrature-phase baseband samples that carry the GMSK signal therein. A channel estimation block operates on the sequences of in-phase and quadrature-phase baseband samples to derive estimates for timing errors (preferably sample timing errors as well as carrier frequency and phase errors) in the samples. The channel estimation block uses the timing error estimates to transform the sequences of in-phase and quadrature-phase baseband samples to compensate for such timing errors. A de-rotation block operates on the transformed sequences to perform a de-rotation of π/2 per symbol in the GMSK signal. The result of the de-rotation is a sequence of complex values each having a real part and an imaginary part. An estimation block uses the result of the de-rotation to derive an estimate for the bits in the GMSK signal. Such estimation is generated by adding a first contribution to a second contribution, the first contribution derived from an imaginary part of a first complex value, and the second contribution derived from a real part of a second complex number. The first and second complex values are spaced apart by one symbol. Such mechanisms and methodologies are readily adaptable for the demodulation of other pre-coded partial response signals.

### BACKGROUND OF THE INVENTION

1. Field of the Invention

This invention relates broadly to demodulation of digital signals and receivers that demodulate digital signals. More particularly, this invention relates to demodulation of pre-coded partial response signals, such as differentially-encoded GMSK signals, and receivers using the same.

2. State of the Art

Gaussian Minimum Shift Keying (GMSK) is a digital modulation scheme commonly used in wireless communications. In GMSK, the phase of a carrier signal is continuously varied by an antipodal signal (sequence of 1 s and −1 s) which has been shaped by a Gaussian filter. The Gaussian filter concentrates the energy allowing for the desirable characteristic of low out-of-band power. This and other advantages (including relatively narrow bandwidth, constant envelope modulation, and immunity to noise and interference) have allowed GMSK to gain acceptance as part of the GSM standard for cellular land mobile radio systems.

GMSK signals may be differentially modulated or coherently modulated. In the case of differential modulation, each successive information bit initiates either a +90 degree or a −90 degree phase rotation relative to the previous phase. In the alternative case of coherent modulation, the final signal phase after completing a +90 degree or a −90 degree rotation is directly indicative of a data bit polarity.

Modem GSM receivers typically filter, down-convert, and sample the received signal in two branches: the in-phase sample (I) and the quadrature-phase sample (Q). These samples are demodulated to recover the symbol stream therein. Such demodulation typically involves differential detection (which may be realized by a one-bit delay, a 90 degree phase shift and a multiply as is well known), channel estimation (which may be realized by correlating received samples with known synchronization words), and Viterbi processing (such as the Maximum Likelihood Sequence Estimation algorithm) which uses the channel estimates and detected symbols in order to compensate for inter-symbol interference. However, the complexity of such techniques grows exponentially with the memory of the modulation and of the channel. Problematically, such complexity adds significant costs to the design and implementation of such receivers.

### SUMMARY OF THE INVENTION

The present invention includes a demodulation mechanism (and corresponding methods of operation) that demodulates a differentially-encoded GMSK signal in a manner that is accurate and efficient and with reduced complexity. The demodulation mechanism includes at least one buffer for storing sequences of in-phase and quadrature-phase baseband samples that carry the GMSK signal therein. A channel estimation block operates on the sequences of in-phase and quadrature-phase baseband samples to derive estimates for timing errors (preferably sample timing errors as well as carrier frequency and phase errors) in the samples. The channel estimation block uses the timing error estimates to transform the sequences of in-phase and quadrature-phase baseband samples to compensate for such timing errors. A de-rotation block operates on the transformed sequences to perform a de-rotation of π/2 per symbol in the GMSK signal. The result of the de-rotation is a sequence of complex values each having a real part and an imaginary part. An estimation block uses the result of the de-rotation to derive an estimate for the bits in the GMSK signal. Such estimation is generated by adding a first contribution to a second contribution, the first contribution derived from the imaginary part of a first complex value, and the second contribution derived from the real part of a second complex number. The first and second complex values are spaced apart by one symbol.

In one embodiment, the channel estimator employs a correlator that detects a predetermined sync-word.

In another embodiment, the de-rotation block generates a vector sequence ŷ(k)=r_{I}(k)′+j r_{Q}(k)′ for n symbols of the GMSK signal, wherein r_{I}(k)′ and r_{Q}(k)′ are the sequences of compensated in-phase and quadrature-phase baseband samples output by the channel estimation block. The de-rotation block further computes a de-rotated vector sequence ŷ(k)′ by multiplying the vector sequence ŷ(k) by j^{-k} such that ŷ(k)′=j^{-k} ŷ(k).

In yet another embodiment, the estimation block generates a vector sequence ŝ(k)=EI(k) y_{I}(k)′+j EQ(k) y_{Q}(k)′ for the n symbols of the GMSK signal, wherein y_{I}(k)′ is the real part of the vector ŷ(k)′ and y_{Q}(k)′ is the imaginary part of the vector ŷ(k)′. EI(k) and EQ(k) are amplitude factors on the two orthogonal axes, these amplitude factors are proportional to the variance of the noise and scaling factor in the receiver at the time corresponding to the given symbol (k). The amplitude factors EI(k) and EQ(k) may be omitted in certain applications. The estimation block further derives the estimate for a given bit in the GMSK signal by adding the imaginary part of (ŝ(k)) to the real part of (ŝ(k+1)).

Receiver architectures that incorporate the demodulation mechanism of the present invention are also disclosed.

Advantageously, the demodulation mechanisms and methodologies of the invention provide accurate and efficient symbol-by-symbol detection of a differentially encoded GMSK symbol. Such mechanisms also have reduced complexity as compared to the prior art designs (complex Viterbi processing can be avoided in many applications or greatly simplified in others), and thus are simple to design and manufacture. Such mechanisms and methodologies are readily adaptable for the demodulation of other pre-coded partial response signals.

Additional objects and advantages of the invention will become apparent to those skilled in the art upon reference to the detailed description taken in conjunction with the provided figures.

### BRIEF DESCRIPTION OF THE DRAWINGS

FIG. 1 is a functional block diagram of an exemplary receiver employing an improved demodulator in accordance with the present invention.

FIG. 2 is a graph that illustrates the phase contribution of adjacent symbols over a sequence of samples in a differentially-encoded GMSK signal.

FIG. 3 is a state diagram that shows possible transitions in the received bit sequence for a differentially-encoded GMSK signal after de-rotation.

### DETAILED DESCRIPTION OF THE PREFERRED EMBODIMENTS

The receiver methodology and mechanisms described below provide for efficient and accurate reception and demodulation of a differentially encoded GMSK signal, such as a GSM wireless radio signal, as well as other pre-coded partial response signals.

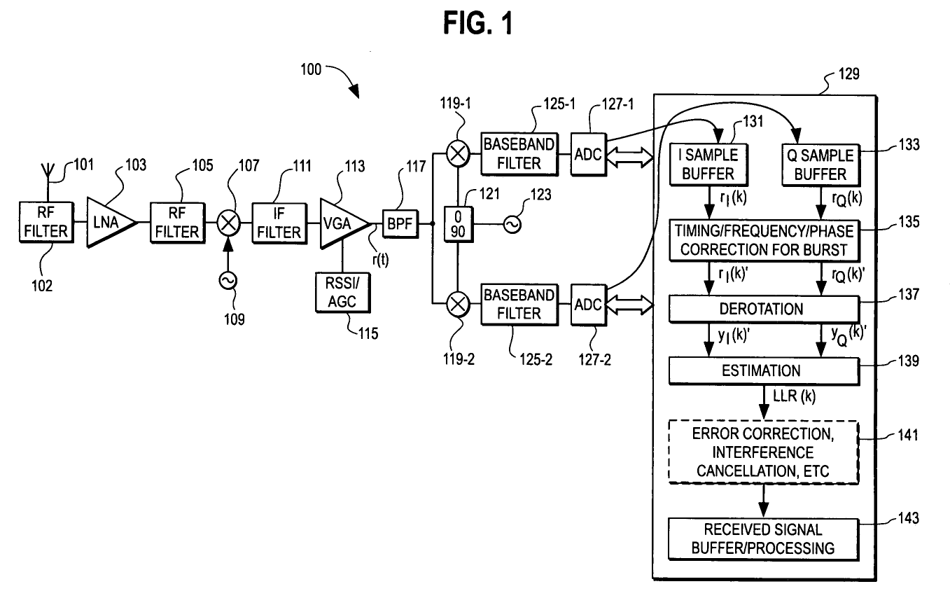

Turning now to FIG. 1, there is shown an improved wireless GMSK radio receiver 100 in accordance with the present invention. The system 100 includes an antenna element 101 that receives radio frequency (RF) signals including a transmitted differentially encoded GMSK signal (for example, transmitted from a base station in a GSM cellular land mobile radio systems). The RF signal from the antenna element 101 is filtered and amplified by filter 102, low noise amplifier 103 and filter 105. A mixer stage 107 down-converts the RF signal output from the filter 105 to an intermediate frequency (IF) signal in accordance with a tuned RF oscillating signal supplied by the tunable RF frequency signal source 109. The output of the down-converting mixer stage 107 is filtered by filter 111 (typically realized by a surface acoustic wave (SAW) type filter) and amplified by a variable gain amplifier 113. The gain of the amplifier 113 is typically controlled in accordance with received signal strength indications (RSSI) and automatic gain control functionality provided by block 115 as is well known. Such gain control ensures that the signal levels at the subsequent stages deliver a constant signal level to the analog-to-digital conversion circuitry 127-1, 127-2. Such constant signal levels are required for accurate demodulation of the GMSK signal. The GMSK signal is labeled r(t) in FIG. 1 and is part of the IF signal output from the amplifier 113 as shown.

The output of the amplifier 113 is supplied to a Gaussian bandpass filter 117 whose output is supplied to two signal processing channels (I channel, Q channel) in parallel. The I channel includes a mixer stage 119-1, baseband filter 125-1, and analog-to-digital conversion circuitry 127-1 that cooperate to sample the in-phase baseband signal that is part of the IF signal supplied thereto. The Q channel includes a mixer stage 119-2, baseband filter 125-2 and analog-to-digital conversion circuitry 127-2 that cooperate to sample the quadrature-phase baseband signal that is part of the IF signal supplied thereto. Such sampling is accomplished by block 121 supplying the in-phase signal (e.g., 0 degree phase offset) of the IF local oscillator source 123 to the I channel mixer stage 119-1 while supplying the quadrature-phase signal (e.g., 90 degree phase offset) of the IF local oscillator source 123 to the Q channel mixer stage 119-2.

In alternate embodiments, a low-IF architecture, a zero-IF direct conversion architecture, or other suitable receiver architecture can be used to extract the in-phase components and quadrature-phase components of the GMSK signal received at the receiver. For example, the analog-to-digital conversion may be performed on the IF signal and the down-conversion to baseband performed in the digital domain. In addition, the analog baseband filters 125-1, 125-2 may be substituted with digital filters (preferably FIR-type low pass filters) that operate in the digital domain (e.g., subsequent to the analog to digital conversion) to eliminate out-of-band noise.

In any case, the in-phase baseband samples as represented in the digital domain (labeled r_{I}(k)) are stored in buffer 131, while the quadrature-phase baseband samples as represented in the digital domain (labeled r_{Q}(k)) are stored in the digital domain in buffer 133.

A channel estimation block 135 operates on the in-phase and quadrature-phase baseband samples (r_{I}(k), r_{Q}(k)) stored in the buffers 131, 133 to detect the presence of a predetermined sync-word (sometimes referred to as a training sequence) in the samples and derives estimates for symbol timing errors as well as carrier frequency errors and phase errors over a burst waveform in the baseband signal. Based upon the error estimates, the channel estimation block 135 transforms the in-phase and quadrature-phase baseband samples that make up a given burst waveform to compensate for such errors. Such compensated samples are labeled r_{I}j(k)′ and r_{Q}(k)′ in FIG. 1. In this manner, the timing, frequency and phase offset for the burst is substantially removed.

The channel estimation block 135 preferably utilizes a correlator to detect the predetermined sync-word. Essentially, the correlator is a matched filer for the sync-word sequence. Thus, the correlator should produce an output with a large magnitude when the sync-word is present. Sync-word detection is declared when the magnitude of the correlation exceeds some threshold. The threshold may be fixed by design or may be dynamically varied. For applications that use automatic gain control, a fixed threshold may lead to a high rate of false detections. This problem may be solved by varying the threshold based upon a noise power estimate that is taken over the samples on which the sync-word correlation operates.

It is theoretically possible to feed the correlator with samples taken at the ideal sampling point. However, in practice, the ideal sampling point is not known. This timing uncertainty can be overcome by oversampling the received waveform and computing correlations to multiple hypotheses of the sample timing. For example, in some systems, the frequency error in the sample clock is small enough that the sampling phase does not vary significantly over the length of the sync-word. Assuming a sampling rate of twice per symbol, one correlation can be performed using only even symbols while another using only odd samples. The accuracy of this approach is often good enough. If not, more sampling hypotheses can be used per symbol.

The oversampling of the received waveform can be obtained by clocking the analog-to-digital conversion at a higher rate (for example, at two times the Nyquist rate), by executing an interpolation filter on the samples of the received waveform, or by correlating to multiple time-shifted versions of the expected sync-word.

The correlation operations are preferably adapted to detect the sync-word coherently, which requires consideration of the carrier frequency error, the symbol rate and the length L of the sync-word. For example, if the symbol rate is L times the carrier frequency error, the carrier will rotate by 360 degrees during the sync-word and the correlation will not detect the sync-word. At smaller carrier frequency errors, there will be some loss in the correlation. If this loss is intolerable, other measures must be taken to compensate for such carrier frequency errors. One possible solution is to hypothesize different carrier frequency errors and attempt correlation for each one with a sequence that is modified by the hypothesized carrier frequency error. While this approach can work well in certain applications, it requires multiple correlations with complex sequences. An alternative is to use differential correlation. Instead of correlating received symbols, the vector cross product of the received symbols (one symbol time apart) are computed and input to the correlator. The differential correlator causes some performance loss as compared to the coherent correlator. But for frequency errors less than a few percent of the symbol rate, the loss does not vary significantly with frequency error and can outperform the coherent correlator with typical amounts of frequency error. In the preferred embodiment, the correlation operations are carried out in two-stage stages including a differential correlation stage that identifies candidates and a coherent correlation stage that verifies candidates when substantial frequency offset is present. These two stages process the received waveform in the frequency domain utilizing a Fast Fourier Transform (FFT) or other similar method.

The channel estimation block 135 may employ one of many ways to derive an estimate of the sample timing error. For example, one technique utilizes the correlation results before and after the correlation peak. The relative magnitude and timing for these results can be mapped to give a timing offset relative to the correlation peak. For example, if the correlation results immediately before and after the peak have equal values, the sample timing error is null. If the correlation result before the peak is larger than the correlation result after the peak, the correlation peak is “late” and the sample timing error is positive (requiring a negative time shift for compensation). If the correlation result before the peak is less than the correlation result after the peak, the correlation peak is “early” and the sample timing error is negative (requiring a positive time shift for compensation).

The channel estimation block 135 may employ one of many ways to derive an estimate of the carrier frequency error. For example, when a differential correlator is used for sync-word detection, the angle of the complex vector output by the correlator at the peak can be used as an estimate for the carrier frequency error, as it is directly proportional to the phase change in one symbol. Similarly, the carrier phase error can be estimated using the phase of the output of the correlator at the peak. This phase is an estimate of the phase of the in-band samples at the middle of the sync-word. Other mechanisms for carrier frequency and phase estimation/tracking are described in detail in “Burst Modem Design Techniques, Part 2,” CSD Magazine, August 1999, herein incorporated by reference in its entirety.

After compensating for the sample timing error as well as the carrier frequency and phase errors, the baseband samples r_{I}(k)′ and r_{Q}(k)′ are operated on by a de-rotation block 137 that performs a π/2 per symbol de-rotation starting from the beginning of the burst waveform. In the preferred embodiment, the de-rotation block 137 operates on a sequence of n time-discrete sample pairs r_{I}(k)′, r_{Q}(k)′ which correspond to a sequence of n symbols that represent the burst waveform in the baseband signal. Each sample pair r_{I}(k)′, r_{Q}(k)′ is converted into a complex representation to form a vector sequence ŷ(k) as follows:
ŷ(k)=r_{I}(k)′+j r_{Q}(k)′, where k=1,2 . . . n for the n symbols of the burst (1)
Then, the de-rotated vector sequence ŷ(k)′ is computed by multiplying the vector sequence ŷ(k) j^{-k} such that
ŷ(k)′=j^{-k}ŷ(k) (2)
The de-rotated vector sequence ŷ(k)′ includes a real part y_{I}(k)′ and an imaginary part y_{Q}(k)′ for each of the n symbols of the burst waveform.

The estimation block 139 operates on the de-rotated vector sequence ŷ(k)′ to generate a vector sequence ŝ(k) for the n symbols of the burst as follows:
ŝ(k)=EI(k)y_{I}(k)′+j EQ(k) y_{Q}(k)′, (3)
where EI(k) and EQ(k) are amplitude factors on the two orthogonal axes, and these amplitude factors are proportional to the variance of the noise and scaling factor in the receiver at the time corresponding to the given symbol (k).
   When the gain is not fixed in each decoding window, equation (3) can be used together with an estimation of channel gain (loss) and noise to obtain a result that is equivalent to adaptive equalization. When the gain is fixed for each decoding window, the amplitude factors EI(k) and EQ(k) can be dropped from equation (3) to yield a simplified form as follows:
   ŝ(k)=y_{I}(k)′+j y_{Q}(k)′ (3a)

The estimation block 139 uses the vector sequence ŝ(k) for the n symbols of the burst to generate a log likelihood ratio LLR (referred to as an “estimate” herein) for the bit stream of the burst as follows:
LLR (dₖ)=imag(\hat{s}(k))+real(ŝ(k+1)) (4)
In other words, the estimate for a given bit in the burst is derived by adding the imaginary part of the vector ŝ(k) for the current detected symbol to the real part of the vector ŝ(k+1), which corresponds to the symbol one-symbol delayed from the imaginary part symbol. The last symbol in the burst is not used. Moreover, there are extra predefined bits at the beginning of the burst, which is inherent to differential encoding.

The bit estimates generated by the estimation block 139 may optionally be loaded into a post-processing block 141 that processes the estimates to cancel interference (such as co-channel interference or multi-path interference), an example of which is set forth in US 2004/0014424 to Kristensson et al, herein incorporated by reference in its entirety. Such post processing may also provide for error correction, which is typically realized by Reed-Solomon decoding or convolutional decoding as part of Viterbi processing.

After decoding is complete, the bit stream generated by block 139 (or block 141) is stored in a received signal buffer 143 for subsequent processing. For example, such processing may carry out communication of the data to the user in handset applications or communication of such data over a network link in base station applications.

The buffers 131, 133 and the data processing blocks 135 through 143 are preferably part of a digital signal processing platform 129, which may be realized by a digital signal processor, an FPGA, an ASIC or other suitable data processing means.

The accuracy and efficiency of the GMSK demodulation mechanisms and methodologies described herein are evident from the following. The phase of GMSK modulated signal is

$$φ ( {t}^{′} ) = {\sum }_{i} {α}_{i} π h {\int }_{- ∞}^{{t}^{′} - iT} g ( u ) ⅆ u \qquad ( 5 )$$

where
h=0.5;
g(u) is Gaussian shaping filter;
aᵢ=1−2\hat{d}ᵢ;
\hat{d}ᵢ=dᵢ⊕dᵢ₋₁(dᵢε{0,1}) (6)
dᵢ are input binary bits, and \hat{d}ᵢ, aᵢ are integer values.

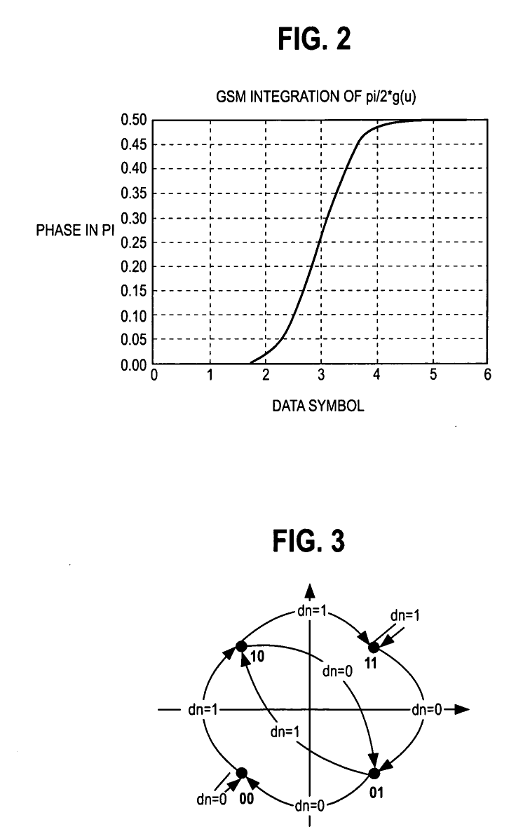

Looking at the graph of FIG. 2 (with i=0) in conjunction with the following equation

$$π h {\int }_{- ∞}^{{t}^{′} - iT} g ( u ) ⅆ u ,$$

if sampling points are represented as integer points in the graph, each symbol's contribution is π/4 for one symbol and roughly another π/4 for the next symbol. Therefore with some adjustment of delay in index for simplicity, equation (5) can be approximated by

$$φ ( nt ) \approx θ ( nt ) = {\sum }_{i = 0}^{n} \{ \frac{π}{4} ( {α}_{i - 1} + {α}_{i} ) \} \qquad ( 7 )$$

It will be appreciated by those skilled in the art that this is only an approximation, and that errors are introduced at sample points 2 (treated as 0) and 4 (treated as π/2) in the above graph.

Substituting equation (6) into (7), the following is obtained:

$$\begin{matrix}θ ( nt ) = {\sum }_{i = 0}^{n} \frac{π}{4} [ ( 1 - 2 {\hat{d}}_{i - 1} ) + ( 1 - 2 {\hat{d}}_{i} ) ] \\ = {\sum }_{i = 0}^{n} \frac{π}{4} [ 2 - 2 {\hat{d}}_{i} - 2 {\hat{d}}_{i - 1} ] \\ = {\sum }_{i = 0}^{n} \frac{π}{2} - {\sum }_{i = 0}^{n} \frac{π}{2} ( {\hat{d}}_{i} + {\hat{d}}_{i - 1} )\end{matrix} \qquad ( 8 )$$

where \hat{d}ᵢ are integer values obtained from binary addition of two adjacent information bits as in equation (6).

It should be appreciated that the first part of equation (8) is a phase rotation at π/2 per symbol, while the second part is

$${θ}_{2} ( nt ) = - \frac{π}{2} {\sum }_{i = 0}^{n} ( {f}_{b 2 i} ( {d}_{i} ⊕ {d}_{i - 1} ) + {f}_{b 2 i} ( {d}_{i - 1} ⊕ {d}_{i - 2} ) ) \qquad ( 9 )$$

where ƒ_{b2i}( ) is a conversion function converting binary to integer as follows
ƒ_{b2i}(0(b))=0;
ƒ_{b2i}(1(b))=1.
Before reducing equation (9), the following consideration should be taken into account:

1. dᵢ=1 for i<0 (assumption of transmit signal). In addition, there are two other simple facts regarding a binary sequence starting with 1. First, it takes an even number of transitions (0−>1 or 1−>0) to reach dₙ=1. Second, it takes an odd number of transitions to reach dₙ=0.

Applying the first of the above statements to equation (9), the following is obtained:

$${θ}_{2} ( nt ) = - \frac{π}{2} ( {f}_{b 2 i} ( {d}_{n} ⊕ {d}_{n - 1} ) - π {\sum }_{i = 1}^{n} {f}_{b 2 i} ( {d}_{i - 1} ⊕ {d}_{i - 2} ) \qquad ( 10 )$$

The 2^{nd} part of equation (10) is actually an information bit sequence transition counter, and each transition will introduce a phase change of π.

From equation (10), the following observations can be made:
1. dₙ=1, dₙ₋₁=1; in this case the 2^{nd} part of equation (10) has an even number of transitions (i.e., the second summation is an even number), and θ₂(nt)=0.
2. dₙ=1, dₙ₋₁=0; in this case, the 2^{nd} part of equation (10) has an odd number of transitions (i.e., the second summation is an odd number), and θ₂(nt)=π/2.
3. dₙ=0, dₙ₋₁=1; in this case, the 2^{nd} part of equation (10) has an even number of transitions (i.e., the 2^{nd} summation is an even number), and θ₂(nt)=−π/2.
4. dₙ=0, dₙ₋₁=0; in this case, the 2^{nd} part of equation (10) has an odd number of transitions (i.e., the 2^{nd} summation is an odd number), and θ₂(nt)=π.

Adding a phase of π/4 provides the following result:

$${θ}_{2} ( nt ) = \{ \begin{matrix}π / 4 & {d}_{n} {d}_{n - 1} = 11 \\ 3 π / 4 & {d}_{n} {d}_{n - 1} = 10 \\ - π / 4 & {d}_{n} {d}_{n - 1} = 01 \\ - 3 π / 4 & {d}_{n} {d}_{n - 1} = 00\end{matrix} \qquad ( 11 )$$

This shows that the second part of the transmitted signal is actually two independent BPSK signals that correspond to the information sequence (the I channel is a one bit delayed version). Therefore, the differential pre-coded GSMK signal has no memory in the signal generation.

A graph of θ₂(nt) and its transition graph is further illustrated in the diagram of FIG. 3.

In conclusion, from equation (8), the phase of transmitted GMSK signal can be decomposed into two parts: a phase rotation at π/2 per symbol; and an instant phase which depends only on the current and previous information bit as stated in equation (10) and (11). Furthermore, there is no memory in the signal generation, and information bits are readily available from the signal constellation when there is no noise or impairment.

In the receiver, if the distortion caused by channel filtering is ignored, a signal similar to equation (8) is received with timing offset and frequency offset and other channel impairments.

Once timing and frequency offset is removed, a de-rotation of π/2 per symbol produces a signal with its phase as stated in equation (11) plus some impairment. The resultant signal is actually a composite of two independent BPSK signals in I and Q space. The imaginary part of the composite signal carries the current information bit and the real part of the composite signal carries the previous information bit.

Since a BPSK type signal is described, the demodulation of the received signal is accomplished in the I/Q domain instead of the A/φ domain to get the most-likely estimation of signal source. I & Q are independent so the received signal after de-rotation can be described as
Ŝₙ=Aₙ₋₁Cₙ₋₁+jBₙCₙ+noise+distortion=R_{I}(n)+jR_{Q}(n) (12)
where Aₙ and Bₙ are the amplitude factors on two orthogonal axes, and normally they are the same and constant;
Cₙ=2*dₙ−1 is the bipolar representation of the information bits.

When only AWGN is present, after de-rotation the real part and the imaginary part of ŝₙ are independent and they are both Gaussian with a mean at x and y. With Gaussian distribution, the symbol log likelihood is given by:
LLR(dₙ)=log(p(dₙ=1)/p(dₙ=0)
This reduces to:
LLR(dₙ)=log{p(Cₙ=1)/p(Cₙ=−1)}=R_{Q}(n)*EQₙ+R_{I}(n+1)*EQₙ₊₁ (13)
where EIₙ and EQₙ₊₁ are proportional to the variance of noise and scaling factor in receiver at the instant in time.

When the gain is not fixed in each decoding window, equation (13) can be used with an estimation of channel gain (loss) and noise to obtain an optimum result, which is equivalent to an adaptive equalization.

If the gain and noise are fixed for each decoding window, EQₙ and EIₙ₊₁ can be dropped without any degradation, such that the symbol estimate for the current symbol LLR(dₙ) is given as:
LLR(dₙ)=R_{Q}(n)+R_{I}(n+1)=imag(ŝ(n))+real(ŝ(n+1)) (14)
This operation is carried out as part of the symbol estimation block 139 of the exemplary receiver system 100 described above.

Advantageously, the demodulation mechanisms and methodologies described herein provide accurate and efficient symbol-by-symbol detection of a differentially encoded GMSK symbol. Such mechanisms also have reduced complexity as compared to the prior art designs (complex Viterbi processing can be avoided in many applications or greatly simplified in others), and thus are simple to design and manufacture, which provides for reduced costs to the end-user.

There have been described and illustrated herein several embodiments of mechanisms and methodologies for the reception and demodulation of a differentially encoded GMSK signal, such as a GSM wireless radio signal. Such mechanisms and methodologies can also be used to receive and demodulate other pre-coded partial response signals. While particular embodiments of the invention have been described, it is not intended that the invention be limited thereto, as it is intended that the invention be as broad in scope as the art will allow and that the specification be read likewise. Thus, while particular receiver architectures have been disclosed, it will be appreciated that other receiver architectures can be used as well. Moreover, the demodulation mechanisms and optionally the other signal processing functionality described herein can be embodied in software (e.g., a programmed sequence of instructions) that is persistently stored in a tangible medium (e.g., an optical disk such as a CD-ROM or a storage device that is part of, or coupled to, a web server) and loaded onto a computer processing platform for execution therein as part of a receiver. It will therefore be appreciated by those skilled in the art that yet other modifications could be made to the provided invention without deviating from its spirit and scope as claimed.

What is claimed is:

1. An apparatus for demodulating a pre-coded partial response signal comprising a sequence of binary values, the apparatus comprising:
at least one buffer for storing a sequence of in-phase baseband samples and a sequence of quadrature-phase baseband samples, said sequence of in-phase baseband samples and said sequence of quadrature-phase baseband samples carrying the partial response signal therein;
a channel estimation block, operably coupled to said at least one buffer, that operates on said sequence of in-phase baseband samples and said sequence of quadrature-phase baseband samples to derive estimates for timing errors in said samples, and that transforms said sequence of in-phase baseband samples and said sequence of quadrature-phase baseband samples to compensate for said timing errors;
a de-rotation block, operably coupled to said channel estimation block, that operates on the transformed sequences of in-phase and quadrature-phase baseband samples to perform a de-rotation of π/2 per symbol in the partial response signal, thereby generating a sequence of complex values each having a real part and an imaginary part; and
an estimation block, operably coupled to said de-rotation block, that derives an estimate for each given bit in the partial response signal by adding a first contribution to a second contribution, the first contribution derived from an imaginary part of a first complex value, and the second contribution derived from a real part of a second complex number, said first and second complex values spaced apart by one symbol.

2. An apparatus according to claim 1, wherein:
said pre-coded partial response signal comprises a differentially encoded GMSK signal.

3. An apparatus according to claim 2, wherein:
said timing errors comprise at least one of sample timing errors, carrier frequency errors, and carrier phase errors.

4. An apparatus according to claim 3, wherein:
said channel estimation block comprises a correlator that detects a predetermined sync-word.

5. An apparatus according to claim 1, wherein
said sequence of compensated in-phase baseband samples are denoted r_{I}(k)′ for n symbols (k=1 . . . n) of the pre-coded partial response signal;
said sequence of compensated quadrature-phase baseband samples are denoted r_{Q}(k)′ for n symbols of the pre-coded partial response signal;
said de-rotation block generates a vector sequence ŷ(k) for n symbols of the pre-coded partial response signal, wherein ŷ(k)=r_{I}(k)′+j r_{Q}(k)′; and
said re-rotation block computes a de-rotated vector sequence ŷ(k)′ by multiplying the vector sequence ŷ(k) j^{-k} such that ŷ(k)′=j^{-k} ŷ(k).

6. An apparatus according to claim 5, wherein:
y_{I}(k)′ is the real part of the vector ŷ(k)′ and y_{Q}(k)′ is the imaginary part of the vector ŷ(k)′, and
said estimation block generates a vector sequence ŝ(k) for the n symbols of the pre-coded partial response signal, wherein ŝ(k)=EI(k)y_{I}(k)′+j EQ(k) y_{Q}(k)′, where EI(k) and EQ(k) are amplitude factors on the two orthogonal axes, these amplitude factors are proportional to the variance of the noise and scaling factor in the receiver at the time corresponding to the given symbol (k).

7. An apparatus according to claim 6, wherein:
said estimation block derives the estimate for a given bit by adding the imaginary part of (ŝ(k)) to the real part of (ŝ(k+1)).

8. An apparatus according to claim 5, wherein
y_{I}(k)′ is the real part of the vector ŷ(k)′ and y_{Q}(k)′ is the imaginary part of the vector ŷ(k)′, and
said estimation block generates a vector sequence ŝ(k) for the n symbols of the pre-coded partial response signal, wherein ŝ(k)=y_{I}(k)′+j y_{Q}(k)′.

9. An apparatus according to claim 8, wherein:
said estimation block derives the estimate for a given bit by adding the imaginary part of (ŝ(k)) to the real part of (ŝ(k+1)).

10. A receiver for receiving a pre-coded partial response signal, the receiver comprising:
a front-end radio subsystem for receiving and down-converting a particular RF channel to an in-phase baseband signal and a quadrature-phase baseband signal, said in-phase baseband signal represented by said sequence of in-phase baseband samples, and said quadrature-phase baseband signal represented by said sequence of quadrature-phase baseband samples; and
the apparatus of claim 1 for demodulating the pre-coded partial response signal, which is coupled to said front-end radio subsystem.

11. A receiver according to claim 10, wherein:
said pre-coded partial response signal comprises a differentially encoded GMSK signal.

12. A method for demodulating a pre-coded partial response signal comprising a sequence of binary values, the method comprising:
storing a sequence of in-phase baseband samples and a sequence of quadrature-phase baseband samples, said sequence of in-phase baseband samples and said sequence of quadrature-phase baseband samples carrying the partial response signal therein;
deriving estimates for timing errors in said samples using said sequence of in-phase baseband samples and said sequence of quadrature-phase baseband samples,
transforming said sequence of in-phase baseband samples and said sequence of quadrature-phase baseband samples to compensate for said timing errors;
operating on the transformed sequences of in-phase and quadrature-phase baseband samples to perform a de-rotation of π/2 per symbol in the partial response signal, thereby generating a sequence of complex values each having a real part and an imaginary part; and
deriving an estimate for each given bit in the partial response signal by adding a first contribution to second contribution, the first contribution derived from an imaginary part of a first complex value, and the second contribution derived from a real part of a second complex number, said first and second complex values spaced apart by one symbol.

13. A method according to claim 12, wherein:
said pre-coded partial response signal comprises a differentially encoded GMSK signal.

14. A method according to claim 13, wherein:
said timing errors comprise at least one of sample timing errors, carrier frequency errors, and carrier phase errors.

15. A method according to claim 14, wherein:
the deriving of timing errors includes correlation that detects a predetermined sync-word.

16. A method according to claim 12, wherein
said sequence of compensated in-phase baseband samples are denoted r_{I}(k)′ for n symbols (k=1 . . . n) of the pre-coded partial response signal;
said sequence of compensated quadrature-phase baseband samples are denoted r_{Q}(k)′ for n symbols of the pre-coded partial response signal;
the de-rotation is accomplished by generating a vector sequence ŷ(k) for n symbols of the pre-coded partial response signal, wherein ŷ(k)=r_{I}(k)′+j r_{Q}(k)′, and computing a de-rotated vector sequence ŷ(k)′ by multiplying the vector sequence ŷ(k) by j^{-k} such that ŷ(k)′=j^{-k} ŷ(k).

17. A method according to claim 16, wherein:
y_{I}(k)′ is the real part of the vector ŷ(k)′ and y_{Q}(k)′ is the imaginary part of the vector ŷ(k)′, and
the estimate is derived by generating a vector sequence ŝ(k) for the n symbols of the pre-coded partial response signal, wherein ŝ(k)=EI(k) y_{I}(k)′+j EQ(k) y_{Q}(k)′, where EI(k) and EQ(k) are amplitude factors on the two orthogonal axes, these amplitude factors are proportional to the variance of the noise and scaling factor in the receiver at the time corresponding to the given symbol (k).

18. A method according to claim 17, wherein:
the estimate is derived for a given bit by adding the imaginary part of (ŝ(k)) to the real part of (ŝ(k+1)).

19. A method according to claim 16, wherein
y_{I}(k)′ is the real part of the vector ŷ(k)′ and y_{Q}(k)′ is the imaginary part of the vector ŷ(k)′, and
the estimate is derived by generating a vector sequence ŝ(k) for the n symbols of the pre-coded partial response signal, wherein ŝ(k)=y_{I}(k)′+j y_{Q}(k)′.

20. A method according to claim 19, wherein:
the estimate is derived for a given bit by adding the imaginary part of (ŝ(k)) to the real part of (ŝ(k+1)).
